(19) United States
(12) Patent Application Publication
(10) Pub. No.: US 2022/0067460 A1
(43) Pub. Date: Mar. 3, 2022

(54) Variance Characterization Based on Feature Contribution

(71) Applicant: Capital One Services, LLC, McLean, VA (US)

(72) Inventors: Rohan Vimal Raj, Dallas, TX (US); Varun Parameswaran, Irving, TX (US); Jie Dai, Plano, TX (US); Aaron Osborne, Plano, TX (US)

(73) Assignee: Capital One Services, LLC, McLean, VA (US)

(21) Appl. No.: 17/006,067

(22) Filed: Aug. 28, 2020

(51) Int. Cl. G06K 9/62; G06N 20/00; G06Q 40/02

(52) U.S. Cl. CPC G06K 9/6298; G06K 9/6289; G06Q 40/025; G06K 9/6256; G06N 20/00; G06K 9/623

(57) ABSTRACT

Systems, methods, and computer readable media are disclosed for generating, modifying, and using machine learning models to predict and evaluate variances between data sets. Methods disclosed herein may include identifying features that characterize members of a data set, generating a machine learning model using identified features, using the machine learning model and the group to assign feature attributions to the features, and predicting the impact of those features on behaviors of the first data set and a second data set.

### BACKGROUND

Predicting and evaluating variances between two or more groups (e.g., multiple populations of individuals, companies, or families, multiple groups of data points, a single group of data points at multiple different periods of time, etc.) can benefit a wide variety of industries.

Traditionally, companies did this by manually trying different hypotheses to establish contributions. This has disadvantages. For example, it is time-consuming and has accuracy problems. The order in which variables were analyzed can affect the result. Also, this manual hypothesis-based process may not account for synergies between the different variables.

In the context of game theory, Shapley values may be used to determine cooperation between different factors. Having its roots in game theory principles, Shapley values are a solution to the problem of how to attribute the impact of a participant (e.g., a particular parameter, a player) to the overall gain of a collective result (e.g., changes in a data set, score in a basketball game). Put another way, Shapely values is a measure of the expected contribution of the participant toward the collective result.

New methods and systems are needed to automate determination of how different factors contribute to a change in the variable.

### BRIEF DESCRIPTION OF THE DRAWINGS/FIGURES

FIG. 1 depicts a block diagram of a system for characterizing variance in data sets based on feature contributions, according to some embodiments.

FIG. 2 depicts a block diagram of a variance characterization server, according to some embodiments.

FIG. 3 depicts a flow diagram illustrating a flow for determining variance of a data set based on feature attributions, according to some embodiments.

FIG. 4 depicts a flow diagram illustrating a flow for determining performance changes between past and current data sets based on feature attributions, according to some embodiments.

FIG. 5 depicts an exemplary waterfall chart displaying two data sets and associated population shifts and features influencing the variance between the data sets, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Disclosed embodiments use the concept of feature attribution to automate the calculations to provide a novel and more efficient method for variance characterization involving multiple data sets. As a non-limiting example, feature attributions may be implemented as Shapley values based on a Shapley value analysis. As a non-limiting example in data sets involving a 2018 loan portfolio and a 2019 loan portfolio, where the data set involves a certain set of customers associated with parameters (e.g., age segment, credit score), Shapley values could be assigned to each of the parameters as a means for determining how those parameters impacted changes between the 2018 portfolio data set and the 2019 portfolio data set.

To allow Shapley values to be used in this way, embodiments rebalance data sets to account for changes in the number of data points. Continuing the example above, embodiments may adjust the data sets to account for differences in the number of loans in the portfolio between 2018 and 2019. Identifying patterns and actionable insights in various population sets involving different types of loans may be useful to parties involved in financial decisions including lenders, financial institutions, investors, and the like. For example, a company may be evaluating a change in a metric and may wish to determine a contribution that various factors have to that change.

In addition, to apply a Shapley value analysis, embodiments may combine the multiple data sets. To distinguish the various data sets once combined, embodiments may add a label to each data point indicating which data set it originated from. Continuing the example above, embodiments combine the 2018 and 2019 portfolio data sets. In the combined data set, embodiments may add a label for each data point describing an individual loan. The data point may be a zero for loans originating from the 2018 portfolio data set and a one for loans originating from the 2019 data set.

Shapley values are used to determine the impact of those respective parameters and identify patterns within the data sets, make predictions based on those identified patterns, and utilize those predictions to automate decisions.

Provided herein are a system, apparatus, device, method and/or computer program product embodiments, and/or combinations and sub-combinations thereof, for generating and utilizing a machine learning model for variance characterization between data sets. To generate and use the machine learning model, a first data snapshot and a second data snapshot associated with a data set may be retrieved.

In some embodiments, the data set may include members and each of the members may be associated with a plurality of features or parameters that characterize the members. Continuing the example above where loan portfolios may be represented by the data set, members include the respective loan accounts within the portfolio and the features of those loan accounts include credit score, age segment, and loan metric such as loan-to-value ratio.

In some embodiments, the first data snapshot of the data set may include a first plurality of data points corresponding to the plurality of features and the second data snapshot may include a second plurality of data points corresponding to the plurality of features. Continuing the example above, the first data snapshot may represent the loan portfolio over a certain time period (e.g., 2018) and the second data snapshot may represent the loan portfolio over another time period (e.g., 2019). A first label may be applied to each data point of the first plurality of data points in the first data snapshot and a second label may be applied to each data point of the second plurality of data points in the second data snapshot.

In some embodiments, the first data snapshot and the second data snapshot may be combined to form a combined data set and first data associated with a first number of data points and second data associated with a second number of data points may be identified from the combined data set. In some embodiments, the first data is identified based on the first label, the second data is identified based on the second label, and the first number is equal to the second number.

In some embodiments, the first and second data from the first and second data snapshots may be used to form a rebalanced data set including a first balanced number of data points and a second balanced number of data points. Rebalancing data between two different groups of data allows for equal number of data points to be used from each of the groups to allow for more accurate calculation of feature attributions between the two different groups.

A machine learning model may then be fitted to the rebalanced data set to generate a fitted machine learning model. Fitting a machine learning model to data means starting with a baseline machine learning model and adjusting the model to match the data so that the model provides a good representation of the data set. The fitted machine learning model may then be used to determine a performance change between the first data snapshot and the second data snapshot. Continuing the example above, the performance change of a data set that involves a loan portfolio may reflect numerical change in a behavior of the portfolio. Examples of behavior in a loan portfolio data set include loss rate and disqualification rates. In a non-limiting example, the performance change is based on the various features that received feature attributions which reflect the impact of the various features on the calculated performance change.

In some embodiments, determining the performance change between the first data snapshot and the second data snapshot further includes generating a first model score based on the fitted machine learning model and the first data snapshot and a second model score based on the fitted machine learning model and the second data snapshot. The model score may represent the accuracy of the fitted machine learning model to predict the data in the first and second data snapshots. In some embodiments, the model score may be a numerical value.

In some embodiments, determining the performance change may further include determining a first feature attribution of a first feature in the plurality of features based on the first model score and determining a second feature attribution of the first feature based on the second model score. The performance change may be determined based on the first feature attribution and the second feature attribution. In some embodiments, the feature attributions may be implemented as Shapley values. In some embodiments, the first feature attribution comprises a first numerical value that reflects how the first data point for the at least one feature impacts the fitted machine learning model and the second feature attribution comprises a second numerical value that reflects how the second data point for the at least one feature impacts the fitted machine learning model.

In some embodiments, steps further include generating a waterfall chart indicating the performance change. The waterfall chart may quantify the impact of each of the features on the performance change.

In some embodiments, model scores may be implemented as probabilities between the actual values of data points in a data set to the calculated values of the fitted machine model. For example, the first model score may reflect a first probability between values of data points in the first data snapshot and calculated values provided by the fitted machine learning model and the second model score may reflect a second probability between values of data points in the first data snapshot and calculated values provided by the fitted machine learning model.

In some embodiments, the first data snapshot represents the data set from a first time period and the second data snapshot represents the data set from a second time period and the fitted machine learning model includes a first model behavior and a second model behavior and the fitted machine learning model is configured to predict values associated with the at least one feature. Implemented in this manner, the fitted machine learning model can determine the impact of features on any variance between data in the first and second data snapshots. Continuing the example above, a model behavior may represent a metric of the data set such as loss rate and delinquency rate.

In some embodiments, prior to applying the first label to the each data point in the first data snapshot, a population shift value is calculated within the first data snapshot. This population shift value may be calculated by fitting a second machine learning model on the first data snapshot to form a second fitted machine learning model. Then a third score may be generated based on the second fitted machine learning model and the first data snapshot and a fourth model score may be generated based on the second fitted machine learning model and the second data snapshot. The population shift value may then be utilized when forming the rebalanced data set. In an embodiment, the population shift value is representative of the values that have shifted the most in comparison to the other data points. In an embodiment, the population shift value may be identified by either undersampling or oversampling of the values within the snapshots. The process of undersampling or oversampling results in adjusting the distribution of values in the data set in order to correct for any of the population shifts that may have occurred

In view of the foregoing description and as will be further described below, the disclosed embodiments enable generation and utilization of a machine learning model to efficiently and accurately analyze data sets and then automating the decisions to adjust future actions by the model.

Various embodiments of these features will now be discussed with respect to the corresponding figures.

### Exemplary Variance Detection System

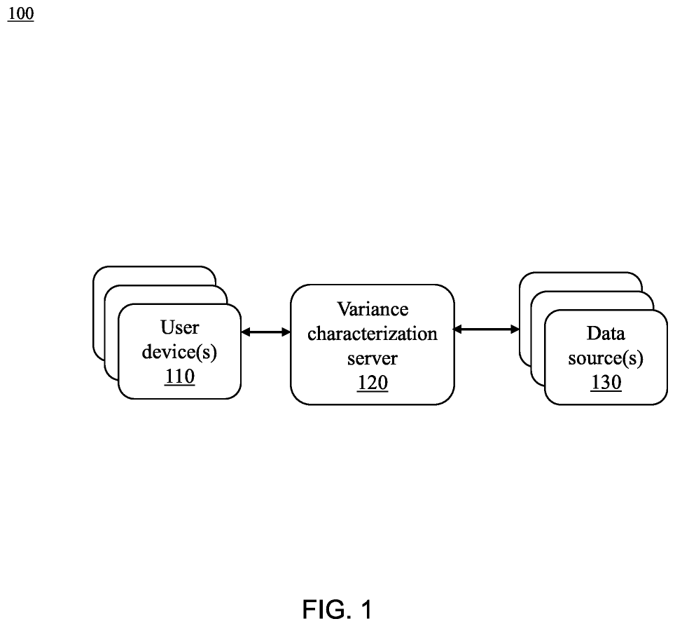

FIG. 1 depicts a block diagram of a system 100 for characterizing variance in data sets based on feature contributions of associated parameters, according to some embodiments. Data sets may be representative of portfolios involving financial vehicles such as loans. Aspects of the present disclosure are directed to solving issues arising from loan servicing and providing predictions of how variables associated with the loans could impact the behavior of future loans. Some examples of behavior associated with loans include loss rate, call rate, delinquency rate (e.g., the number of delinquent loans out of a total number of loans in a portfolio), approval rate, or any kind of metric associated with a particular account for the loan.

As a non-limiting example involving loan assessment, a first data set may have a first delinquency rate, and a second data set may have a second delinquency rate that is different from the first delinquency rate. Each of the data sets is associated with a number of different parameters, such as credit score of people receiving the loans, age segment of the people, months on book. System 100, using a machine learning method, such as a gradient boosting machine or a neural network for analysis, may be utilized to determine how those different parameters impacted the change of the first delinquency rate and the second delinquency rate. Other metrics may be considered in addition to delinquency rates such as loss rate and call rate.

User devices 110 may include any combination of devices, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, augmented reality headsets, etc.), a personal computer (PC), or a similar type of device that enables users to interact with data sets provided by variance characterization server 120. In some embodiments, user devices 110 allow interactions with the data sets and the results of any variance analysis provided by variance characterization server 120. User devices 110 may provide an interface for displaying or interacting with results of the variance analysis. Results may include a waterfall chart that depicts the cumulative effect of different values as they are added or subtracted. In some embodiments, a waterfall chart is produced by variance characterization server 120 based on the feature attributions that are assigned to different parameters associated with the analyzed data set.

In a non-limiting example, each data set may include a number of different members, each member being associated with a number of variables that characterize members of the data set. Examples of members include loan accounts and customers. Examples of variables include age segments (e.g., 20-30), geographic location, credit score (e.g., FICO), financial metrics such as loan-to-value (LTV) ratios and month on book (MOB), and service-related metrics such as call intensity (how often a customer is contacted by telephone). MOB refers to a number of complete months that have elapsed since the origination date of a purchased loan. In some embodiments, each of these variables may be assigned a feature attribution value, such as a Shapley value, that reflects a measure of that variable's impact on the overall changes between data sets (e.g., 2018 data set for a financial institution vs. 2019 data set).

User devices 110 may include components for scheduling and queueing requests for data analyses or predictions received via a displayed interface. User devices 110 may additionally be configured to forward notifications to the interface upon completion of a data analysis or prediction.

Variance characterization server 120 may be implemented as one or more server device (e.g., a host server, a web server, an application server, etc.), a data center device, or a similar device, capable of communicating with user devices 110 and data sources 130. In some embodiments, server 120 may be implemented as a plurality of servers that function collectively as a distributed database. In some embodiments, server 120 may be used to perform the variance characterization functions between data sets retrieved from data sources 130. In some embodiments, variance characterization server 120 may implement machine learning to provide accurate predictions as to expected differences and similarities between members of a data set.

In some embodiments, variance characterization server 120 may be configured to convert requests for data analyses or predictions received from user devices 110 into a packaged data format which may be used for the analysis. Variance characterization server 120 may be configured to sort and analyze data, generate and modify machine learning models, identify similarities and differences between data sets, and predict and analyze differences between the data sets using generated and modified machine learning models. In some embodiments, variance characterization server 120 may include a plurality of computing devices working in concert to perform data analyses and to predict differences between data sets according to methods described further herein.

Data sources 130 may be implemented as one or more devices either remote from server 120 or installed as a component of server 120. Data sources 130 may include one or more databases, storage systems, and/or inputs which may provide data describing groups, members of groups, and/or variables characterizing members of groups. For example, data sources 130 may include one or more cloud- or server-based databases, computers, computer systems, server systems, and/or cloud systems. Data may be provided to data sources 130 from any compatible source, via user or automated input (e.g., over a wired or wireless connection). Data sources 130 may receive, store, and/or provide data in a similar or different format. For example, data sources 130 may be configured to provide data in a particular file format, such as a comma-separated values format (CSV) or other common file format.

### Exemplary Variance Detection Server

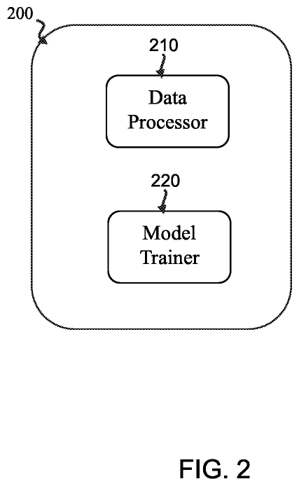

FIG. 2 depicts a block diagram of a variance characterization server 200, according to some embodiments. In some embodiments, variance characterization server 200 represents an implementation of variance characterization server 120 of FIG. 1. Variance characterization server 200 may include data processor 210 and model trainer 220.

Data processor 210 is a component for performing the variance characterization. Data processor 210 receives requests for data analyses or predictions (e.g., from user devices 110) and perform the variance characterization analysis based on the received requests. The analysis may include generating and modify machine learning models, identifying similarities and differences between data sets, and predicting and analyzing the differences between the data sets using the generated and modified machine learning models.

Data processor 210 also may be configured to calculate the feature attribution values associated with features that are detected and provided by model trainer 220. Examples of feature attribution values include Shapley values and are used to reflect a numerical measure of a feature's impact on the overall differences between compared data sets. For example, data processor 210 may be requested to analyze data sets from different years that have a variance between a feature such as loan delinquency (i.e., the loan delinquency rate in one year is lower or higher than the loan delinquency rate in another year). Data processor 210 may assign feature attribution values to certain features of the data sets to measure the impact of the feature on the variance. Continuing the example of loan delinquency, data sets may include parameters that characterize the population into different segments. For example, data processor 210 may assign feature attribution values to credit scores, age segments of the population, and LTV associated with each loan. Those feature attribution values may reflect the impact of those parameters on the differences in loan delinquency rate between the different years.

Model trainer 220 includes components for generating models to be used for performing the analysis by data processor 210. Model trainer 220 may include components for sorting the parameters into categories and transforming them into simplified indicators of shifts between data sets which allows for similar variables and data sets to be treated in a similar manner. Model trainer 220 may utilize the feature attribution values to generate machine learning models that are specific to predictions and analyses based on particular data sets and particular variables. By integrating feature attribution values with machine learning, the accuracy of the analyses is improved. Specifically, the feature attribution values are utilized to interpret the model's output.

In some embodiments, model trainer 220 generates a prediction model such as a gradient boosting machine (GBM) model as a prediction model, or other random forest techniques. In an alternative embodiment, model trainer 220 may employ a different model such as a neural network. In an example, the prediction model is a tree-based model that is utilized for detecting interactions between variables in a data set and making predictions of how those variables would impact the generated model.

### Exemplary Methods

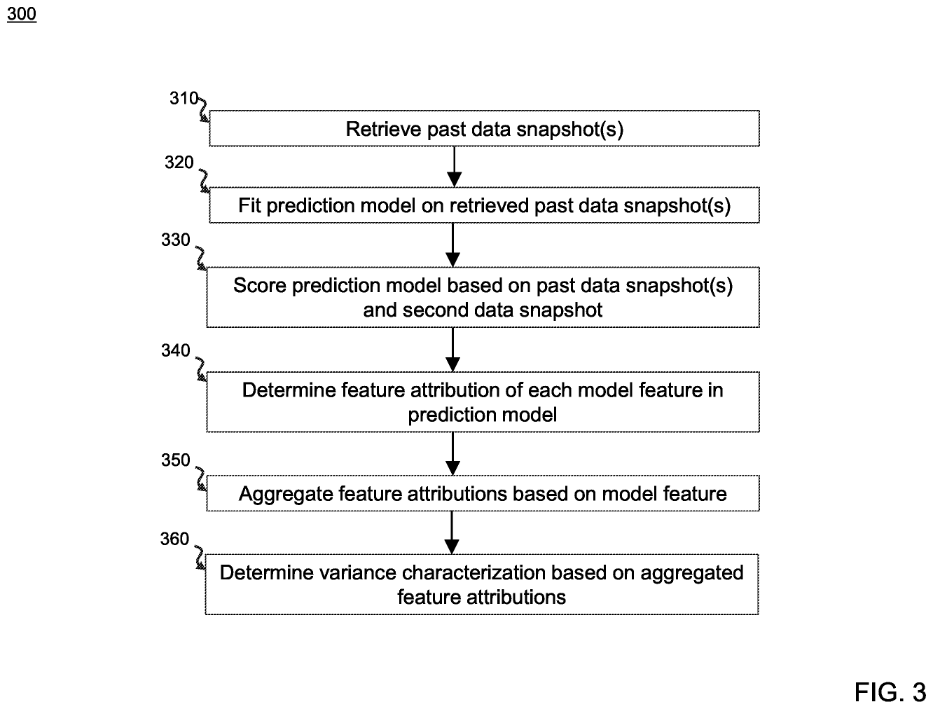

FIG. 3 depicts a flow diagram illustrating a flow for determining variance of a data set based on feature attributions, according to some embodiments. As a non-limiting example with regards to FIGS. 1-2, one or more processes described with respect to FIG. 3 may be performed by a server (e.g., variance characterization server 120 of FIG. 1). In such an embodiment, server 120 may execute code in memory to perform certain steps of method 300 of FIG. 3. While method 300 of FIG. 3 will be discussed below as being performed by server 120, other devices including may store the code and therefore may execute method 300 by directly executing the code. Accordingly, the following discussion of method 300 will refer to devices of FIGS. 1-2 as an exemplary non-limiting embodiment of method 300. Moreover, it is to be appreciated that not all steps may be needed to perform the disclosure provided herein. Further, some of the steps may be performed simultaneously or in a different order than shown in FIG. 3, as will be understood by a person of ordinary skill in the art.

In some embodiments, method 300 may be used to detect population shifts between a base data set and a compare data set. Population shifts may represent an underlying shift in the data set. In an example where the data set reflects a loan portfolio (with a number of members or loan accounts), the population shift may represent an underlying shift in the loan portfolio across each of the loan accounts. The base data set may be represented by a data snapshot that includes historical data from a certain time frame (e.g., 2018, 2019).

In 310, a past data snapshot is retrieved (e.g., by variance server 120). In some embodiments, the past data snapshot may include data collected from a previous time frame such as the year 2018. The retrieved data snapshot reflects the base data from which a model can be generated to make predictions based on the variables associated with the data snapshot. In some embodiments, more than one data snapshot may be retrieved. Each data snapshot may have a number of members; examples of members include loan accounts and customers, and each of the members have the same associated features, such as credit score, age segment, and LTV.

In 320, a machine learning (or prediction) model is fitted onto the retrieved data snapshot. Fitting a model onto the data in the snapshot may include starting with a baseline model and iteratively adjusting the model to match the data that is provided. Steps for the iterative adjustment may include parameter tuning where a subset of the data is used to identify the metrics of the data; metrics may include maximum depth, minimum child weight, learning rate, and subsample. Parameter tuning can be achieved by using a Grid Search based on an evaluation metric or accuracy metric. In some embodiments, cross validation and early stopping metrics can also be used to ensure that the final baseline model has least out-of-sample variance. The final baseline model is one with the highest accuracy and least out-of-sample variance. Fitting the model onto the data involves determining the best values for these metrics.

In some embodiments, a subset of the data from the past data snapshot is used to tune the model based on the calculated metrics and the remaining subset is used to train and evaluate the model. The end result of the fitting process is a model that matches the data provided in the past data snapshot.

In 330, the generated machine learning (or prediction) model is “scored” based on the past data snapshot retrieved in 310 along with a second data snapshot, such as one reflecting a different time frame. In some embodiments, that time frame may reflect a “current” time frame such as the current year or month. The “score” reflects a measure of how well the prediction model predicts the data provided in the past data snapshot and the second data snapshot for the features (or parameters) of that data set.

In an example when the data set involves a loan portfolio, features of the past data snapshot and the second data snapshot may include credit score, age segment, and age of the loan (or months on book). Scoring the prediction model involves determining the accuracy of the prediction model to predict the data sets in the past data snapshot and the second data snapshot.

In 340, the feature attribution of each model behavior is determined using the scores of the prediction model. The prediction model may be used to predict a behavior such as a predicted delinquency of loans represented in the snapshots. This step may involve deriving how each model behavior influences the model by assigning a feature attribution value to each model. In an example where the model is directed toward delinquency in the loan data, each model behavior (e.g., credit score, age segment) is assigned a feature attribution value that that reflects the influence of that feature on the behavior (e.g., delinquency) in the past data snapshot and the current data snapshot. In an embodiment, the feature attribution value is a Shapley value and the feature attribution is generated using a Shapley methodology.

In some embodiments, 340 is performed separately for the past data snapshot and the second data snapshot. In such embodiments, the feature attribution value assigned to each model behavior measure the likely influence of that feature on the respective data sets in the previous and second data snapshots.

In 350, the determined feature attributions are aggregated across the members of the data set. In some embodiments, this aggregation is performed separately for features of the past data snapshot and the second data snapshot. This aggregation allows feature attributions assigned within the data snapshot to be grouped based on the specific feature. For example, in an example where the data snapshot reflects a loan portfolio that includes two features, credit score and age segment, the feature attributions for these features may be aggregated across the separate members (e.g., loan accounts) to provide a single feature attribution value for each the features. That is, the feature attribution value of credit score is reflective of all loan accounts having that credit score.

In 360, the variance between the features in the snapshots is characterized based on the aggregated feature attributions from the past data snapshot and the aggregated feature attributions from the current data snapshot. In some embodiments, this characterization involves determining a difference in value between the aggregated feature attributions. In some embodiments, when aggregating feature attributions, the difference is calculated between the sum of the Shapley values from the current data snapshot and the sum of Shapley values in a past data snapshot. In some embodiments, this characterization represents a population shift between the features of the past data snapshot and the second data snapshot and is measured by calculating a population shift value based on the fitted prediction model generated in 320, utilizing the model score generated based on the fitted prediction model and the past data snapshot in 330 and the model score generated based on the fitted prediction model and the current data snapshot.

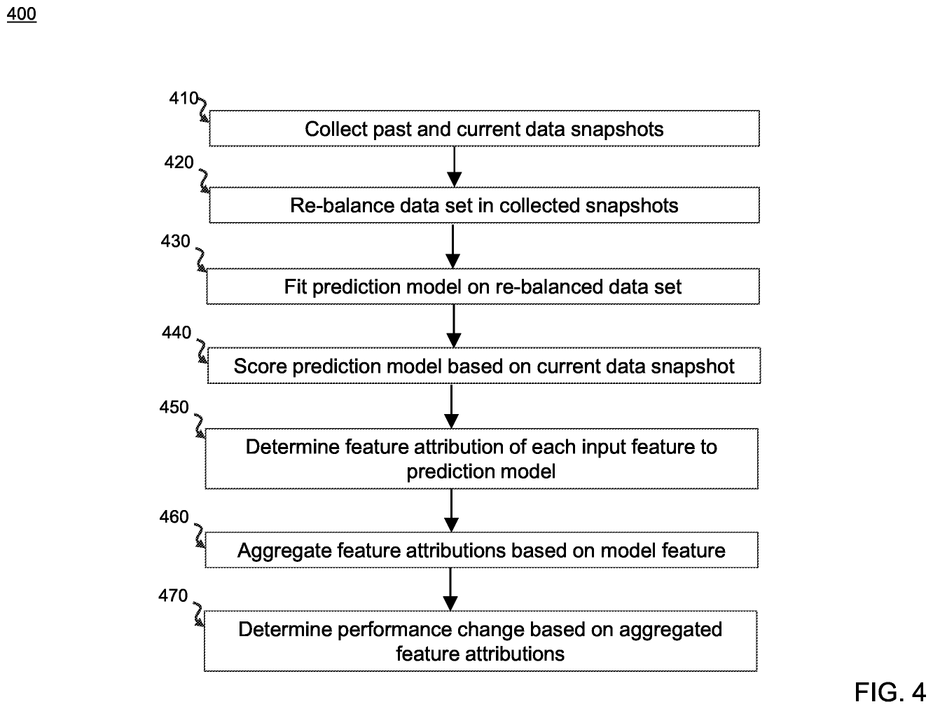

FIG. 4 depicts a flow diagram of an example method 400 illustrating a flow for generating a model and testing a website based on the generated model, according to some embodiments. As a non-limiting example with regards to FIGS. 1-2, one or more processes described with respect to FIG. 4 may be performed by a server (e.g., variance characterization server 120 of FIG. 1). In such an embodiment, server 120 may execute code in memory to perform certain steps of method 400 of FIG. 3.

While method 400 of FIG. 4 will be discussed below as being performed by server 120, other devices may store the code and therefore may execute method 400 by directly executing the code. Accordingly, the following discussion of method 400 will refer to devices of FIGS. 1-2 as an exemplary non-limiting embodiment of method 400. Moreover, it is to be appreciated that not all steps may be needed to perform the disclosure provided herein. Further, some of the steps may be performed simultaneously or in a different order than shown in FIG. 4, as will be understood by a person of ordinary skill in the art.

In some embodiments, method 400 may be used to generate a second prediction model for determining a performance change between the past data snapshot and the second data snapshot. Performance changes may represent a change (improvement or worsening) at a segment-level within the data set. In an example where the data set reflects a loan portfolio (with a number of members or loan accounts), the population shift may represent an underlying shift in the loan portfolio across each of the loan accounts. In some embodiments, method 300 occurs prior to method 400 (e.g., prior to step 410 which involves applying the labels to the data sets).

In the embodiment discussed below, past data snapshot and current data snapshot are discussed where the past data snapshot reflects data collected from a past time period and the current data snapshot reflects data collected from a current time period. Method 400 is not limited to this specific implementation but may utilize data organized in any variety of formats.

In 410, a past data snapshot and current data snapshot is retrieved (e.g., by variance server 120). In some embodiments, the snapshots are combined to form a single data set that includes data from both snapshots. In some embodiments, past data snapshot and a current data snapshot are associated with a single data set that includes a plurality of features (or features as discussed above), and the past data snapshot includes a plurality of data points corresponding to the plurality of features and the current data snapshot includes a second plurality of data points corresponding to the plurality of features. In some embodiments, the first data snapshot represents the single data set from a first time period and the second data snapshot represents the single data set from a second time period

In some embodiments, combining the snapshots includes applying a first label to each data point of the first plurality of data points in the past data snapshot and applying a second label to each data point of the second plurality of data points in the current data snapshot. In some embodiments, the data point represents the member, such as a loan account, within the data snapshot, that may reflect a loan portfolio. The first and second labels may be used to distinguish the data points from other data points within the different snapshots after they have been merged into form the single data set. For example, a loan account from a past snapshot (e.g., 2019) is applied a first label while that same loan account from a current snapshot (e.g., 2020) is applied a second label. After merging, data associated with a certain number of data points may be identified in the combined data set based on the first label and data associated with a certain number of data points may be identified in the combined data set based on the second label. In some embodiments, the first number is equal to the second number such that the number of data points identified by the first label is equal to the number of data points identified by the second label.

In 420, the data set is re-balanced to form a rebalanced data set. The rebalanced data set includes a first balanced number of data points from the first data snapshot and a second balanced number of data points from the second data snapshot. Rebalancing means taking the same number of data points (e.g., loan accounts) from each data snapshot and based on the data points characterized by the first and second labels. Taking the same number of data points in this calculation prevents double-counting the impact of each feature within method 300 and 400. In some embodiments, the population shift value that is generated in method 300 may be used when forming the rebalanced data set. In an embodiment, the population shift value identifies features with the largest population shift feature attribution. When utilizing Shapley values, the population shift value identifies features with the largest Shapley values. Using the population shift value in forming the rebalanced data set allows the population shift to be normalized within the rebalanced data set.

In 430, the machine learning (or prediction) model is fitted to the rebalanced data set to generate a fitted machine learning (or prediction) model. In some embodiments, the fitted machine learning model includes a first model behavior and a second model behavior and the fitted machine learning model is configured to predict values associated with the at least one feature. Examples of model behavior include delinquency rate or loss rate and examples of features include credit score and age segment.

In 440, a first model score is generated based on the fitted machine learning model and the first data snapshot and a second model score is generated based on the fitted machine learning model and the second data snapshot. In some embodiments, the first model score reflects a first probability between the values of data points in the first data snapshot with the calculated values provided by the fitted machine learning model; similarly, the second model score reflects a second probability between the values of data points in the first data snapshot and calculated values provided by the fitted machine learning model.

In 450, a first feature attribution of a first feature in the plurality of features is determined based on the first model score and a second feature attribution of the first feature is determined based on the second model score. In some embodiments, the first feature attribution comprises a first numerical value that reflects how the first data point for the at least one feature impacts the fitted machine learning model and the second feature attribution comprises a second numerical value that reflects how the second data point for the at least one feature impacts the fitted machine learning model.

In 460, the determined feature attributions are aggregated for each member of the data set. In some embodiments, the feature attributions for each member (e.g., account) are aggregated into a waterfall chart that indicates how each feature associated with that account is moving the prediction for the machine learning model. In some embodiments, this aggregation is performed separately for features of the past data snapshot and the second data snapshot. This aggregation allows feature attributions assigned within the data snapshot to be grouped based on the specific feature.

In 470, a performance change between the first data snapshot and the second data snapshot is determined based on the fitted machine learning model. In some embodiments, the performance change is determined based on taking a difference between the first feature attribution and the second feature attribution. In some embodiments, the waterfall charts generated for each member are aggregated (from 450) to form a single waterfall chart; a waterfall chart may be generated that reflects the performance change.

One benefit of methods 300 and 400 is that the calculated feature attributions are independent of any order in which the features are used to generate the machine learning model. In prior art systems, the order in which the features are impacted the influence of first inputted features. Therefore, the impact of the first inputted feature would be exaggerated while later inputted features into the machine learning model would have been minimized. Using methods 300 and 400, the feature attributions are independent of the order in which the features are used for generating the machine learning which provides a more accurate attribution of that feature's impact on the behavior of the model.

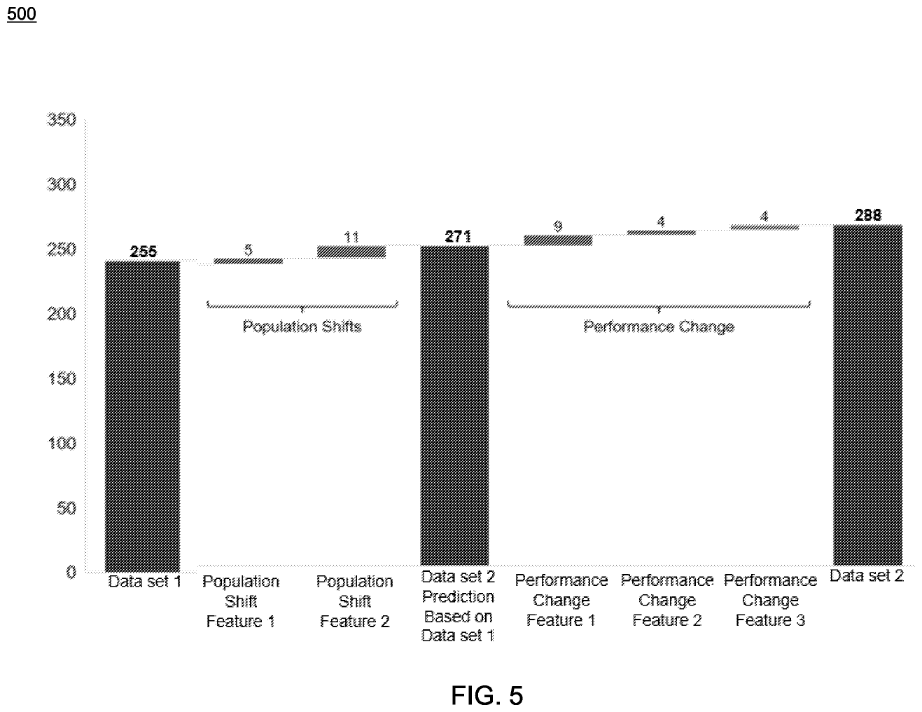

FIG. 5 depicts an exemplary waterfall chart displaying two data sets and associated population shifts and features influencing the variance between the data sets, according to some embodiments.

FIG. 5 includes a chart showing bars for a first data set (“Data Set 1”) and a second data set (“Data Set 2”), each represented by an overall metric (e.g., numerical value, as shown on the y-axis). The middle bar “Data Set 2 Prediction based on Data Set 1” represents a predicted value of Data Set 2, using the machine learning model as generated in methods 300 and 400, that is based on the values of data set 1. As shown, there is a difference of 33 between the first data set and the second data set. The difference between the data set 2 prediction and the first data set represents population shift; the difference between the second data set and the data set 2 prediction represents the performance change.

The population shift is attributable to population shift feature 1 which has been assigned a feature attribution value of 5 and population shift feature 1 which has been assigned a feature attribution value of 11 (e.g., as a result of execution of method 300). The performance change is attributable to performance change features 1-3 which have been assigned 9, 4, and 4 respectively (e.g., as a result of execution of method 400).

### Exemplary System Implementation

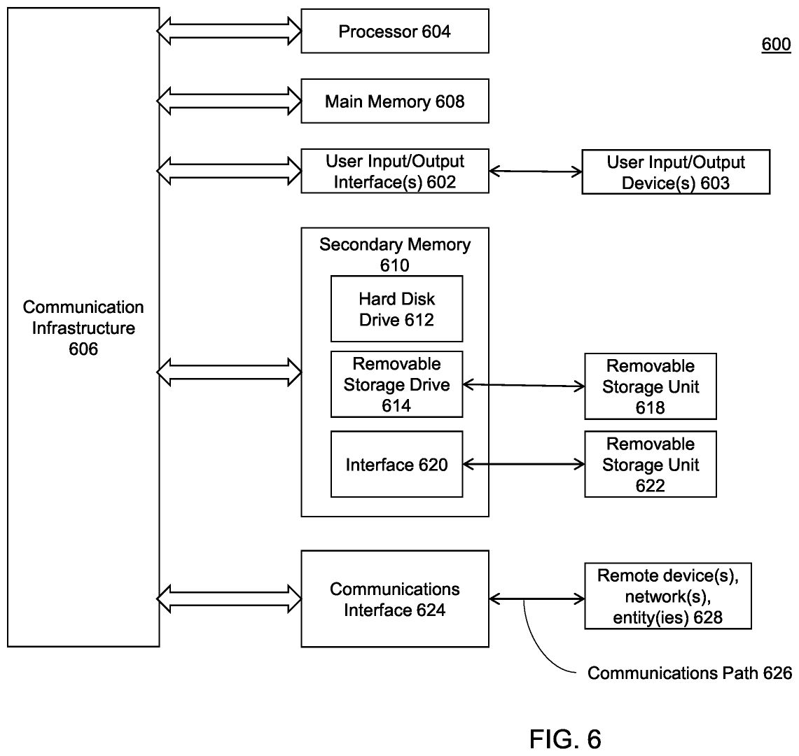

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed:

1. A computer-implemented method for generating and utilizing a machine learning model for variance characterization between data sets, the method comprising:
retrieving a first data snapshot and a second data snapshot of a data set, wherein the data set includes a plurality of members and wherein each member of the plurality of members in the first data snapshot includes a first plurality of data points and each member of the plurality of members in the second data snapshot includes a second plurality of data points ;
applying a first label to each data point of the first plurality of data points in the first data snapshot;
applying a second label to each data point of the second plurality of data points in the second data snapshot;
combining the first data snapshot and the second data snapshot to form a combined data set;
identifying, from the combined data set, first data representing a first number of data points and second data representing a second number of data points, wherein the first data is identified based on the first label, the second data is identified based on the second label, and the first number is equal to the second number;
forming a rebalanced data set including a first balanced number of data points from the first data and a second balanced number of data points from the second data;
fitting the machine learning model to the rebalanced data set to generate a fitted machine learning model; and
determining, based on the fitted machine learning model, a performance change between the first data snapshot and the second data snapshot.

2. The method of claim 1, wherein the plurality of members are characterized by at least one feature and determining the performance change between the first data snapshot and the second data snapshot further comprises:
generating a first model score based on the fitted machine learning model and the first data snapshot;
generating a second model score based on the fitted machine learning model and the second data snapshot;
determining a first feature attribution of the at least one feature based on the first model score; and
determining a second feature attribution of the at least one feature based on the second model score,
wherein the performance change is determined based on the first feature attribution and the second feature attribution.

3. The method of claim 2, wherein the first model score reflects a first probability between values of data points in the first data snapshot and calculated values provided by the fitted machine learning model and the second model score reflects a second probability between values of data points in the second data snapshot and calculated values provided by the fitted machine learning model.

4. The method of claim 2, wherein the first feature attribution comprises a first numerical value that reflects how the first data point impacts the fitted machine learning model and the second feature attribution comprises a second numerical value that reflects how the second data point impacts the fitted machine learning model.

5. The method of claim 1, wherein the first data snapshot represents the data set from a first time period and the second data snapshot represents the data set from a second time period.

6. The method of claim 1, wherein the fitted machine learning model includes a first model behavior and a second model behavior and the fitted machine learning model is configured to predict values associated with the at least one feature.

7. The method of claim 1, prior to applying the first label to the each data point in the first data snapshot, the method further comprising:
calculating a population shift value within the first data snapshot by:
fitting a second machine learning model on the first data snapshot to form a second fitted machine learning model;
generating a third model score based on the second fitted machine learning model and the first data snapshot;
generating a fourth model score based on the second fitted machine learning model and the second data snapshot; and
utilizing the population shift value when forming the rebalanced data set.

8. The method of claim 7, wherein calculating the population shift value further comprises:
determining a third feature attribution of the first model behavior based on the third model score;
determining a fourth feature attribution of the first model behavior based on the fourth model score; and
calculating the population shift value based on a difference between the third feature attribution and the fourth feature attribution.

9. The method of claim 1, wherein the machine learning model is one of a gradient boosting model or a random forest model.

10. The method of claim 1, wherein the first balanced number of data points is equal to the second balanced number of data points.

11. A non-transitory computer-readable medium storing instructions, the instructions, when executed by a processor, cause the processor to perform operations comprising:
retrieving a first data snapshot and a second data snapshot of a data set, wherein the data set includes a plurality of members and wherein each member of the plurality of members in the first data snapshot includes a first plurality of data points and each member of the plurality of members in the second data snapshot includes a second plurality of data points;
determining a population shift between the first data snapshot and the second data snapshot;
applying a first label to each data point of the first plurality of data points in the first data snapshot;
applying a second label to each data point of the second plurality of data points in the second data snapshot, wherein the first label and the second label differentiate each data point in the first data snapshot from each data point in the second snapshot;
combining the first data snapshot and the second data snapshot to form a combined data set;
identifying, from the combined data set, first data representing a first number of data points and second data representing a second number of data points, wherein the first data is identified based on the first label and the first number is equal to the second number;
forming, based on the population shift, a rebalanced data set including a first balanced number of data points from the first data and a second balanced number of data points from the second data;
fitting a machine learning model to the rebalanced data set to generate a fitted machine learning model; and
determining a performance change between the first data snapshot and the second data snapshot using the fitted machine learning model.

12. The non-transitory computer-readable medium of claim 11, wherein the plurality of members are characterized by at least one feature and determining the performance change between the first data snapshot and the second data snapshot further comprises:
generating a first model score based on the fitted machine learning model and the first data snapshot;
generating a second model score based on the fitted machine learning model and the second data snapshot;
determining a first feature attribution of the at least one feature based on the first model score; and
determining a second feature attribution of the at least one feature based on the second model score,
wherein the performance change is determined based on the first feature attribution and the second feature attribution.

13. The non-transitory computer-readable medium of claim 12, wherein the first model score reflects a first probability between values of data points in the first data snapshot and calculated values provided by the fitted machine learning model and the second model score reflects a second probability between values of data points in the second data snapshot and calculated values provided by the fitted machine learning model.

14. The non-transitory computer-readable medium of claim 12, wherein the first feature attribution comprises a first numerical value that reflects how the first data point for impacts the fitted machine learning model and the second feature attribution comprises a second numerical value that reflects how the second data point impacts the fitted machine learning model.

15. The non-transitory computer-readable medium of claim 11, wherein the first data snapshot represents the data set from a first time period and the second data snapshot represents the data set from a second time period.

16. The non-transitory computer-readable medium of claim 11, wherein the fitted machine learning model includes a first model behavior and a second model behavior and the fitted machine learning model is configured to predict values associated with the at least one feature.

17. The non-transitory computer-readable medium of claim 11, prior to applying the first label to the each data point in the first data snapshot, the operations further comprising:
calculating a population shift value within the first data snapshot by:
fitting a second machine learning model on the first data snapshot to form a second fitted machine learning model;
generating a third model score based on the second fitted machine learning model and the first data snapshot; and
generating a fourth model score based on the second fitted machine learning model and the second data snapshot.

18. The non-transitory computer-readable medium of claim 17, wherein calculating the population shift value further comprises:
determining a third feature attribution of the first model behavior based on the third model score;
determining a fourth feature attribution of the first model behavior based on the fourth model score; and
calculating the population shift value based on a difference between the third feature attribution and the fourth feature attribution.

19. The non-transitory computer-readable medium of claim 11, wherein the machine learning model is one of a gradient boosting model or a random forest model.

20. A computer-implemented method for generating and utilizing a machine learning model for characterizing changes between data sets:
a memory; and
a processor communicatively coupled to the memory and configured to:
retrieve a first data snapshot and a second data snapshot of a data set, wherein the data set includes a plurality of members and wherein each member of the plurality of members in the first data snapshot includes a first plurality of data points and each member of the plurality of members in the second data snapshot includes a second plurality of data points;
applying a first label to each data point of the first plurality of data points in the first data snapshot;
applying a second label to each data point of the second plurality of data points in the second data snapshot;
combining the first data snapshot and the second data snapshot to form a combined data set;
identifying, from the combined data set, first data representing a first number of data points and second data representing a second number of data points, wherein the first data is identified based on the first label and the first number is equal to the second number;
forming a rebalanced data set including a first balanced number of data points from the first data and a second balanced number of data points from the second data;
fitting a machine learning model to the rebalanced data set to generate a fitted machine learning model;
determining, using the fitted machine learning model, a performance change between the first data snapshot and the second data snapshot associated with the plurality of features; and
generating a waterfall chart indicating the performance change.
